(19) United States
(12) Patent Application Publication
(10) Pub. No.: US 2009/0071059 A1
(43) Pub. Date: Mar. 19, 2009

(54) ADHESIVE TRAP FOR MOSQUITOES

(75) Inventors: Alessandra Della Torre, Roma (IT); Luca Facchinelli, Roma (IT); Marco Pombi, Roma (IT); Ian Paul Reiter, Paris (FR)

Correspondence Address: JUNEAU PARTNERS, P.O. BOX 2516, ALEXANDRIA, VA, 22301, US

(73) Assignee: AMA DISINFESTAZIONI S.R.L., Roma (IT)

(21) Appl. No.: 11/914,496

(22) PCT Filed: May 23, 2006
(86) PCT No.: PCT/IT2006/000389

§ 371 Date: Sep. 22, 2008

(30) Foreign Application Priority Data
May 24, 2005 (IT) RM2005A000256

(51) Int. Cl. A01M 1/14

(52) U.S. Cl. 43/114

(57) ABSTRACT

Trap for mosquito mainly constituted by a base (2) , a basket (3) and a cover (4), characterized in that: the base (2) has a clear colour, contrasting with respect to the one of the basket (3); the basket (3) has a dark colour, contrasting with respect to the one of the base (2); the cover (4) is mainly constituted by a covering member (8) and by partitions which can be fixed with greater length than the one of the height of the basket (3) so that the covering member (8) does not rest onto the edge (9) of the basket (3) and leaves then an opening (10), wherein the partitions delimitate niches and house adhesive disposable slips of paper, whereon the mosquitoes remain attached.

Mosquitoes are insects of relevant sanitary importance, not only because their stings can cause cutaneous and allergic reactions even of relevant entity, but above all due to their capability of acting as carriers of pathogenic agents, some thereof (e.g. the malaria Plasmodes and the viruses of the yellow fever and of Dengue) are responsible for millions of deaths and for hundreds of millions of infections each year.

Some species of mosquitoes, in particular some species belonging to Aedes, Ochlerotatus and Culex genera are defined as “container-breeding” owing to their ability to lay eggs and undergo their larval cycle in small pockets of stagnant water, either natural (e.g. cavity in the trees) and anthropic (e.g. pots, pot dishes, used tarpaulins). This behaviour allows the use of artificial containers, developed ad hoc to capture gravid females during the deposition phase (traps for adults) or the eggs laid by them (ovitraps). Such containers distributed over a territory have a high possibility of being visited by gravid females, since these mosquito species distribute the eggs deriving from the same gonotrophic cycle in several places, this guaranteeing that they reach the adult state of at least a part of the descendants.

Traps for capturing gravid females described by the patent and not patent prior art are:
Ritchie S. A., Long S., Smith G., Pyke A. and T. B. Knox, 2004. “Entomological investigations in a focus of dengue transmission in Cairns, Queensland, Australia, by using the sticky ovitraps” Entomological Society of America, 41, No. 1, wherein an adhesive trap similar to an ovitrap with an adhesive strip on the inner edge of the container and containing a 50% solution of hay brew is described.
US 2001/0000059. Inventors: Perich M. J. and Zeichner B. C. “Lethal mosquito breeding container” filed on Nov. 29, 2000, wherein a lethal ovitrap with deposition surface impregnated with deltametrine (insecticide) is described.

Furthermore, “ovitraps” (small pots full of water placed inside a masonite small rod, where the mosquitoes lay the eggs, which then are counted with a microscope) are traditionally utilized for monitoring the population dynamics of these species of mosquitoes.

The authors of the present invention have developed a trap able to attract and capture females looking for a resting place and/or possible places suitable for laying the eggs. With respect to the traps for adults described above, the subject trap has a structure which amplifies the capture surface and increases its attractiveness not only to gravid females, but also to females looking for resting places, thus maximizing the capture efficiency, as demonstrated by the comparison of the results reported for the traps mentioned above and those obtained in the experimentation described hereinafter.

The subject trap is used both to evaluate the infestation intensity and the population dynamics of these mosquito species and to develop an inexpensive and efficient control strategy which, for example, could be used to capture Aedes albopictus (tiger mosquito) in Italy and Aedes aegypti (main carrier of yellow fever) and Culex quiquefasciatus (carrier of filarias and encephalitogenic viruses) in tropical areas.

Therefore, an object of the present invention is a trap for mosquitoes mainly constituted by a base 2, a basket 3 and a cover 4, wherein:
the base 2 has a light colour, contrasting with respect to the colour of the basket 3;
the basket 3 has a dark colour, contrasting with respect to the colour of the base 2;
the cover 4 is mainly constituted of a covering member 8 and partitions, which can be fixed, with greater length than the one of the height of the basket 3 so that the covering member 8 does not rest onto the edge 9 of the basket 3 and therefore so that it leaves an opening 10, wherein the partitions delimitate recesses and house adhesive disposable slips of paper, whereon the mosquito remains attached.

Preferably, the basket 3 has a substantially cylindrical shape and/or proper horizontal groovings 5.

Preferably each partition, in the outer upper portion is equipped with an attraction member, with a contrasting colour with respect to the one of the basket 3.

Preferably, the adhesive slips of paper comprise an adhesive layer only in the upper portion thereof which is not dipped in the water.

The trap for mosquitoes of the invention is particularly efficient for mosquitoes belonging to the species Aedes albopictus, Aedes aegypti or Culex quiquefasciatus.

The present invention will be now described in a not limitative embodiment thereof, with particular reference to the following figures and by providing functionality data:

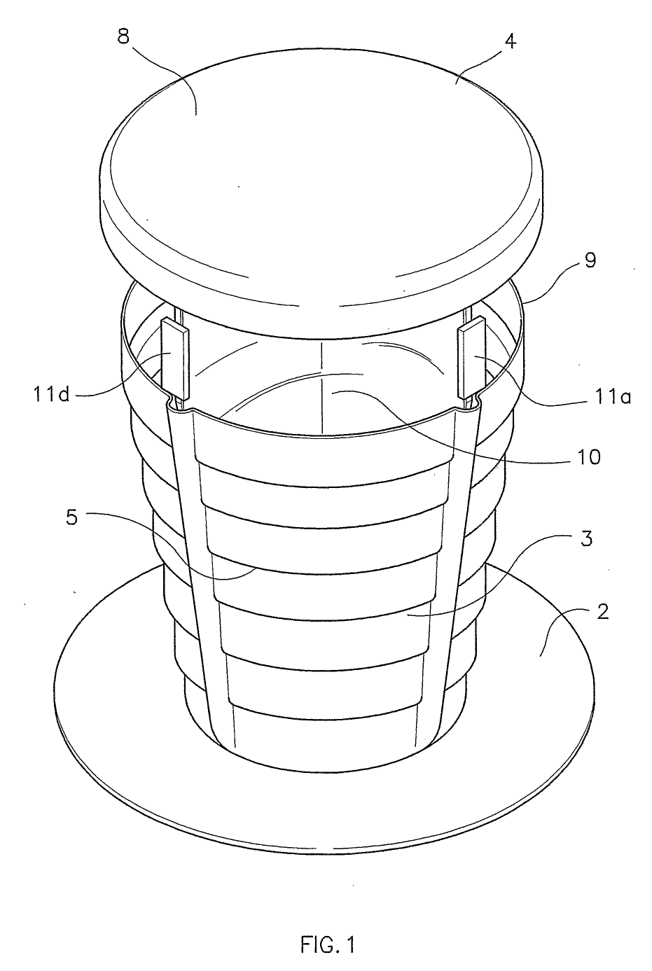

FIG. 1. Perspective side view of the trap.

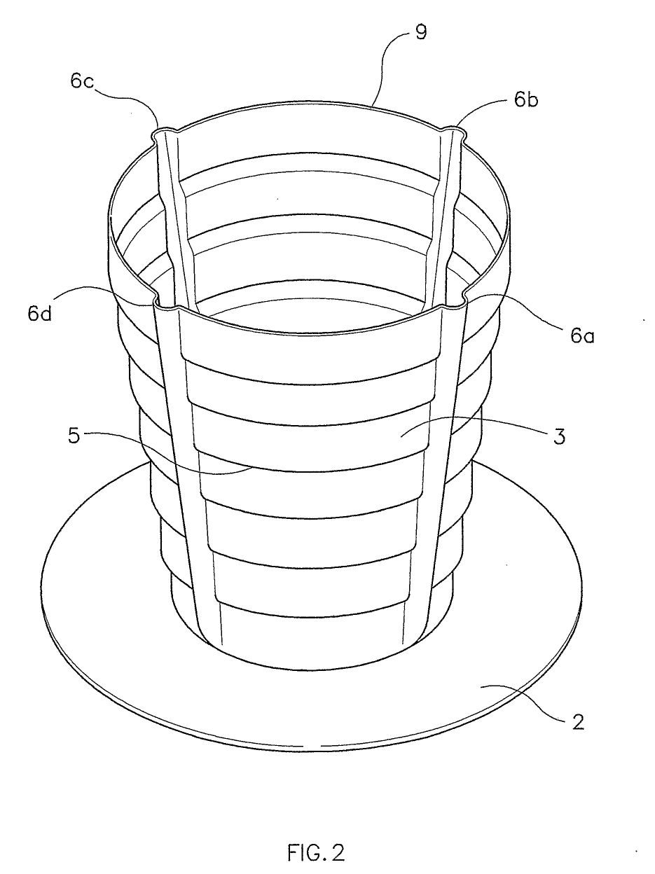

FIG. 2. Perspective side view of the base and of the basket of the trap.

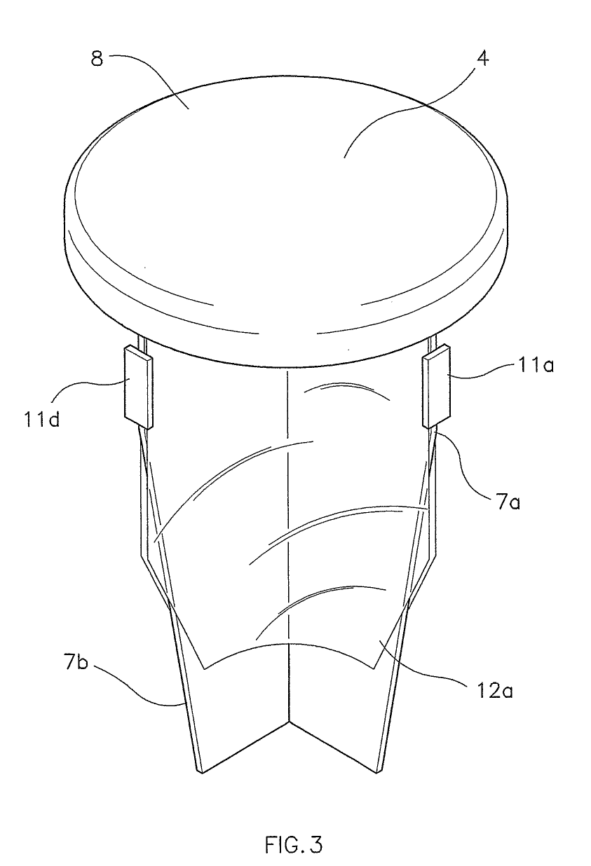

FIG. 3. Perspective top view of the cover of the trap wherein the inner partitions are visible.

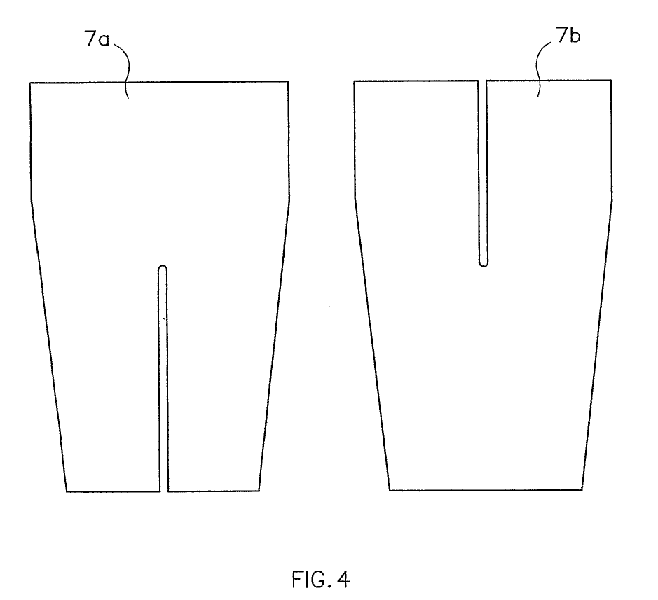

FIG. 4. Side view of the two inner partitions 7a and 7b of the cover.

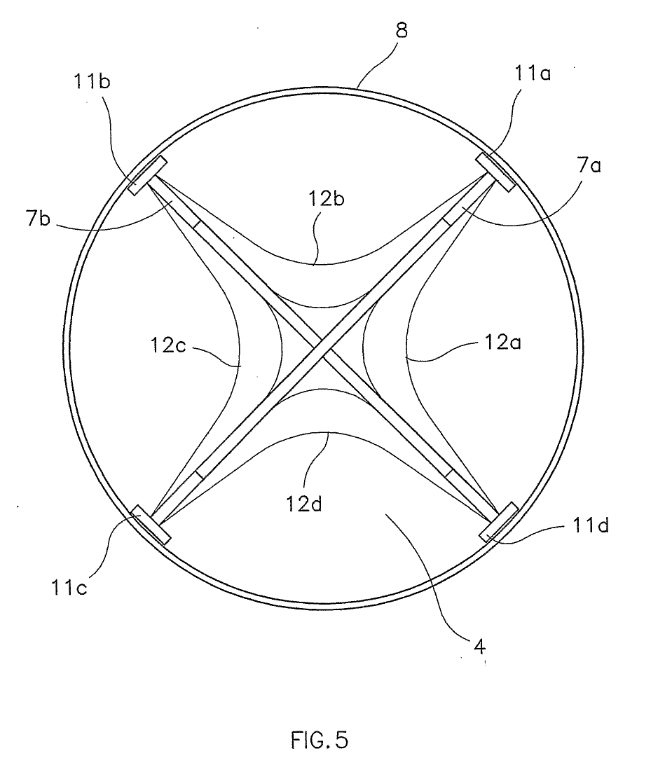

FIG. 5. Bottom view of the cover of the trap.

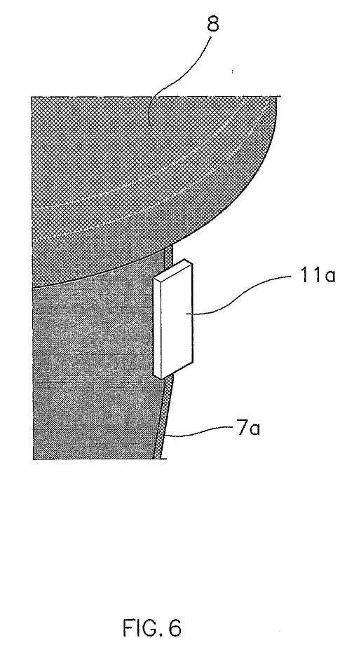

FIG. 6. Enlarged detail of the coloured member contrasting on the outer portion of the partitions of the cover of FIG. 2.

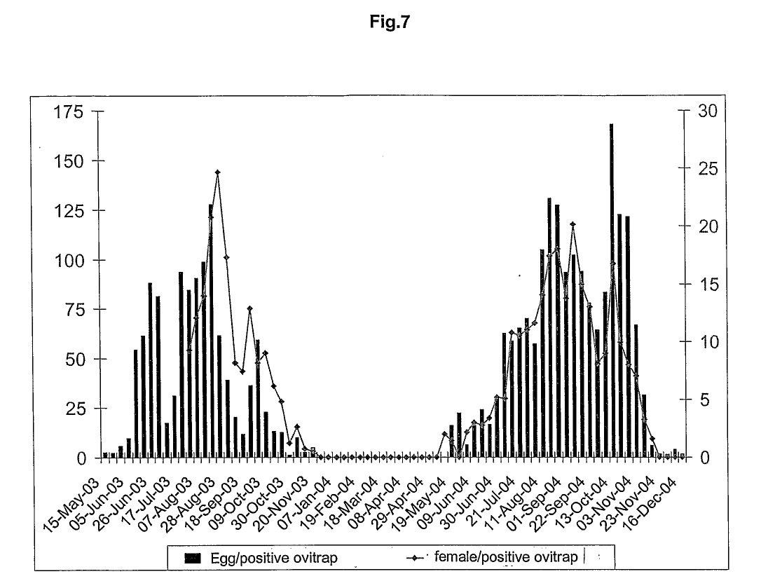

FIG. 7. Comparison graph (geometrical averages) between two monitoring methods (traps and ovitraps) in a park in Rome.

In an embodiment and by referring to the figures the trap 1 is composed by a base 2, a basket 3 and a cover 4.

The base 2 has a substantially circular shape and has a greater diameter than the one of the basket 3 and of the cover 4. The base 2 advantageously has a clear colour, contrasting with respect to the one of the basket 3, for example white. Its function is to stabilize the trap and to attract the mosquitoes with the white/black contrast.

The basket 3 has a mainly cylindrical shape, preferably like a truncated cone, with proper horizontal grooves 5 which allow stiffening the structure and with vertical grooves 6a, 6b, 6c, 6d, respectively able to act as guides of the partitions 7a and 7b of the cover 4. The basket 3 advantageously has a dark colour, contrasting with respect to the one of the base 2, for example black. The basket 3 has the task of housing a water volume of about 500 ml so as to fill-in it for about ⅔ of its volume.

The cover 4 mainly is constituted by a covering member 8 with circular shape and by two partitions 7a and 7b which can be cross-fixed with greater length than the one of the height of the basket 3, so that the covering member 8 does not rest onto the edge 9 of the basket 3 and it leaves then an opening 10 therethrough the mosquitoes enter.

The covering member 8 advantageously has a dark colour, contrasting with respect to the one of the base 2, for example black.

Each partition 7a and 7b in the upper portion is equipped with outer sides of an attraction member 11a, 11b, 11c and 11d, with a contrasting colour with respect to the one of the basket 3, for example white.

The partitions 7a and 7b delimitate four niches and house adhesive disposable slips of paper 12a, 12b, 12c and 12d, in position opposed to the basket, whereon the mosquitoes remain attached. Advantageously, the slips of paper are covered with adhesive only in the upper portion but not in the one dipped in the water of the basket 3.

In the period comprised within August 2003 and November 2004, a study about the capture efficiency of the trap of the invention in a roman park, localized in one of the most infested town councils in the Rome city, was performed, as confirmed by the monitoring by means of ovitraps performed by the “Istituto Superiore di Sanitá” (“Institute of the federal board of health”) during the last years.

In the 16 hectares of the examined area 60 glue traps of the invention (equal to about 3.8 traps/hectare) were positioned, reduced then to 20 in 2004; the adhesive surfaces were then replaced weekly and the captured mosquitoes were identified and counted.

In this context, the traps resulted to be extremely selective towards the females of Ae. albopictus (tiger mosquito). In fact, in the first four months of use (August-November 2003), 11,820 females of Ae. albopictus (11 females per trap each week) were captured against 1,020 males of Ae. albopictus, 278 females and 75 males of Culex pipiens (common mosquito). The rate of the weekly capturing of tiger mosquito females resulted to be very variable during the experimental season, comprised between 20.4 individuals captured in August and 1.5 in November.

In order to compare the data obtained from the glue traps with a standardized sampling method, starting as from May 2003 the population dynamics of the tiger mosquito has been monitored by means of ovitraps. The results (FIG. 7) show how the progress of the population dynamics obtained from the ovitraps can be overlapped to the one obtained with the data obtained from the glue traps; the analysis confirms that the two sets of data are correlated to a high significativeness (Pearson correlation coefficient r transformed log(1+χ) equal to 0.93 with P<0.001).

Based upon these preliminary studies, it is then possible to state that the glue trap results efficient in capturing females of Ae. albopictus and in monitoring the population dynamics, having some considerable advantages with respect to the ovitraps, linked to the fact that the glue trap captures adult females instead of eggs. This implies various advantages:
1. a considerable time saving in the counting phase: the number of adult females can be easily detected on the field, at time of changing the adhesive slips of paper. In this way the work of counting the eggs with the microscope, necessary in case of the ovitraps, is avoided.
2. the possibility of leaving the trap active without maintenance even for long periods (and then to save resources), since it does not allow that the eggs be laid and that they hatch in the basket 3. On the contrary, the ovitraps require a weekly control to avoid that the larvae derived from the eggs laid therein produce a new generation of adults.
3. the possibility of eliminating the fraction of the adult population of Ae. albopictus and therefore to be able to be utilized as control means, above all in the initial growing phases (spring).

1. Trap for mosquito mainly constituted by a base 2, a basket 3 and a cover 4, characterized in that:
the base 2 has a clear colour, contrasting with respect to the one of the basket 3;
the basket 3 has a dark colour, contrasting with respect to the one of the base 2;
the cover 4 is mainly constituted by a covering member 8 and by partitions which can be fixed with greater length than the one of the height of the basket 3 so that the covering member 8 does not rest onto the edge 9 of the basket 3 and leaves then an opening 10, wherein the partitions delimitate niches and house adhesive disposable slips of paper, whereon the mosquitoes remain attached.

2. Trap for mosquitoes according to claim 1, wherein the basket 3 has a substantially cylindrical shape and/or proper horizontal grooves 5.

3. Trap for mosquitoes according to the preceding claims, wherein each partition in the outer upper portion is equipped with an attraction member, with a contrasting colour with respect to the one of the basket 3.

4. Trap for mosquitoes according to claim 3, wherein the adhesive slips of paper comprise an adhesive layer only in the upper portion thereof which is not dipped in the water.

5. Trap for mosquitoes according to one of the preceding claims, wherein the mosquitoes belong to the species Aedes albopictus, Aedes aegypti or Culex quiquefasciatus.
